(19) United States
(12) Patent Application Publication
(10) Pub. No.: US 2013/0211917 A1
(43) Pub. Date: Aug. 15, 2013

(54) LOCAL AREA ADVERTISEMENT MANAGEMENT

(71) Applicant: Uniloc Luxembourg S.A., (US)

(72) Inventor: Craig S. ETCHEGOYEN, Newport Beach, CA (US)

(73) Assignee: UNILOC LUXEMBOURG S.A., Luxembourg (LU)

(21) Appl. No.: 13/743,133

(22) Filed: Jan. 16, 2013

Related U.S. Application Data
(60) Provisional application No. 61/597,649, filed on Feb. 10, 2012.

(30) Foreign Application Priority Data
Apr. 24, 2012 (AU) 2012100461

(51) Int. Cl. G06Q 30/02

(52) U.S. Cl. CPC G06Q 30/0261
USPC 705/14.58

(57) ABSTRACT

A local area advertising server limits distribution of advertisements to computing devices, preferably mobile computing devices, that are carried by people likely to be in close physical proximity to a store or location to which the advertisements pertain and likely to be currently engaged in activities relevant to the advertisements. Advertisements from a specific store can be delivered immediately through the Internet to people physically inside the store. Computing devices coupled to a local area network located in or near a store or other location are presumed to be physically in or very near the store or location. By associating advertisements with local area networks to which they pertain, only advertisements associated with the local area network to which the computing device is connected are sent to the computing device.

This application claims priority to U.S. Provisional Application No. 61/597,649, which was filed Feb. 10, 2012, and which is fully incorporated herein by reference.

### BACKGROUND OF THE INVENTION

1. Field of the Invention

The present invention relates generally to network-based computer services and, more particularly, to methods of and systems for delivering advertisements through portable, personal, computing devices that are in relatively close physical proximity to advertisers.

2. Description of the Related Art

Many traditional advertising methods are not targeted to a specialized class of consumer, but are instead “mass mailings” that consist of printed publications that are widely disseminated in hopes of reaching a fraction of interested consumers. For example, such advertisements may be inserted into each and every local newspaper to be delivered to every subscriber in the area. To the extent such advertising can be considered targeted at all, it would be to residents in a general geographical region.

The advent of the Internet brought about a somewhat refined form of mass mailing. Advertisers disseminating offers through electronic mail have a better indication of recipient interest in the advertised goods and services through transactional histories involving consumer e-mail accounts, which, unlike residential addresses, cannot be easily discovered without consumer input. However, such advertisements are not at all geographically targeted.

Interposed between these advertising methods is a need for highly targeted electronic advertising. A large chain of stores may covers a geographical area wide enough to warrant sending advertisements to all residents of a region or to sending advertising to every Internet user likely to have a specific interest in the goods or services advertised. However, individual shops of the chain, and independent stores as well, have varying demand from location to location. For example, one location might see high demand for sandals while another might see high demand for work boots. Each location needs to be able to selectively promote items that are in less demand to clear inventory for new stock.

What is needed is a way for each store to instantly promote goods or services directly to people who are reasonably likely to shop at that particular store.

### SUMMARY OF THE INVENTION

In accordance with the present invention, a local area advertising server limits distribution of advertisements to people likely to be in close physical proximity to a store or location to which the advertisements pertain and likely to be currently engaged in activities relevant to the advertisements. In other words, for the first time, advertisements from a specific store can be immediately delivered through the Internet to people physically inside the store. Computing devices coupled to a local area network located in or near a store or other location are presumed to be physically in or very near the store or location. By associating advertisements with local area networks to which they pertain, only those advertisements associated with the local area network to which the computing device is connected are sent to the computing device.

In effect, the computing device of a shopper receives only advertisements for deals, sales, offers, etc. that are nearby and none others. The computing device can request such advertisements when initiated by the user through physical manipulation of one or more user input devices. Alternatively, the computing device can be configured to automatically request such advertisements upon connecting to a local area network.

In one embodiment the present invention provides a method for disseminating local area advertising to a computing device. The method comprises the following steps executed at a local area advertising server: receiving a data record from a point-of-sale computing system, the data record including an advertisement and identifying an associated local area network through which the advertisement is to be delivered; receiving a request for advertisements from the computing device through a computer network, wherein the request identifies the local area network to which the computing device is connected; identifying the advertisement that is associate with the local area network; and sending the advertisement to the computing device.

In another form of the invention, the data record received from the point-of-sale computing system is not transmitted through the local area network. In another form, the computing device is a mobile computing device wirelessly connected to the local area network.

In another embodiment, the present invention provides a computer system comprising: at least one processor; a computer readable medium that is operatively coupled to the processor; network access circuitry that is operatively coupled to the processor; and local area advertising server logic (i) that executes in the processor from the computer readable medium and (ii) that, when executed by the processor, causes the computer to facilitate local area advertising to a computing device by at least: receiving a request for advertisements from the computing device through a computer network, wherein the request identifies the local area network to which the computing device is connected; identifying the advertisement that are associated with the local area network; and sending the advertisement to the computing device.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a portable computing device coupled to a local area network, a point-of-sale system operated by an advertising merchant, and a local area advertising server computer that facilitate local area advertising to the portable computing device in accordance with one embodiment of the present invention.

FIG. 2 is a transaction diagram illustrating one embodiment according to the invention of a method by which the local area advertising server computer of FIG. 1 facilitates local area advertising to the portable computing device of FIG. 1.

FIG. 3 is a block diagram of a merchant data record associated with the point-of-sale system of FIG. 1.

FIG. 4 is a block diagram showing in greater detail an advertisement record of the merchant data record of FIG. 3.

FIG. 5 is a block diagram showing the portable computing device of FIG. 1 in greater detail.

FIG. 6 is a block diagram showing the local area advertising server of FIG. 1 in greater detail.

### DETAILED DESCRIPTION

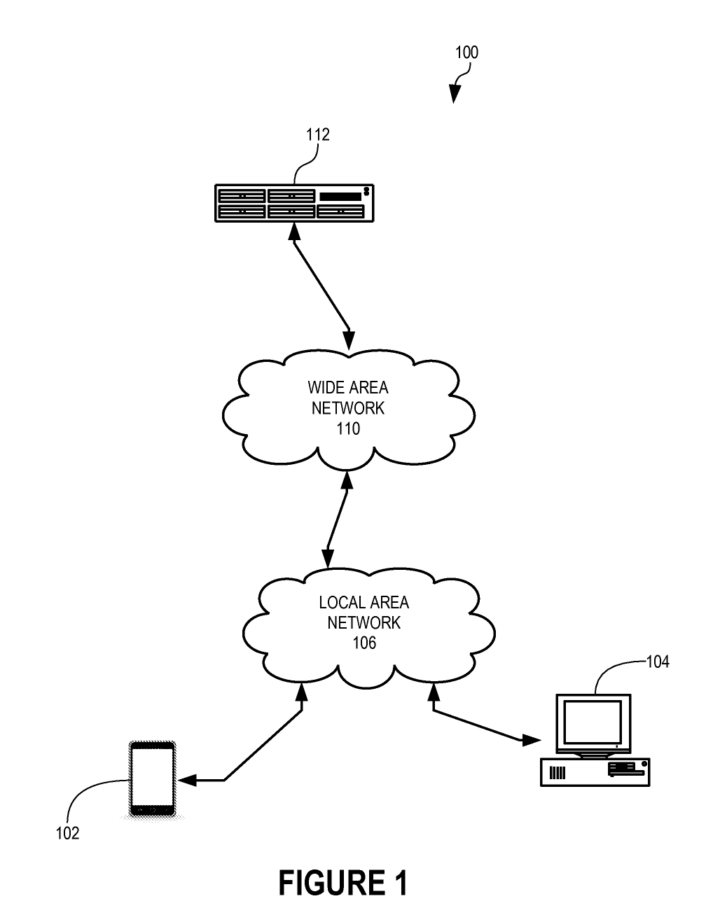

In accordance with the present invention, a local area advertising server 112 (FIG. 1) limits advertisements to people likely to be in close physical proximity to an advertiser. In particular, local area advertising server 112 sends advertisements only to computing devices that are connected to a local area network associated with the advertiser.

The advertising merchant may upload via the local area network 106 advertisements of sales, deals, offers, etc. at any time. For example, if sandals are in high demand and work boots are under sold and over stocked, the merchant can immediately announce a large discount for work boots. Shoppers carrying devices 102 who are physically present in the store at that time or who are perhaps nearby are immediately notified of the discount. And, consumers who are not physically located within or near the store are not notified until they come into or near to the store.

From the shopper's perspective, the shopper can immediately see all deals, sales, etc. for the store she is physically inside or near. The shopper can be assured that no exceptional pricing will go unnoticed. In addition, the advertisements can be organized for easy browsing using the full processing power and graphical user interface of today's portable computing devices rather than paper fliers that are still handed out to shoppers entering a store today.

Local area networks are typically managed by a single entity and, as their name suggests, only cover a local area. Accordingly, relatively close physical proximity can be safely assumed between computing devices and access points of a local area network through which they are connected. In addition, areas covered by a local area network are typically primarily intended for a single type of activity.

For example, consider a local area network (LAN) in a shopping mall. People using portable devices connected to the LAN would very likely be willing and ready to shop. Accordingly, while many prefer not to see advertisements when engaged in other activities, people engaged in shopping are often highly interested in finding the best available deals and are therefore more accepting, perhaps welcoming, of advertisements for shops in which they are currently shopping. Similarly, a LAN at a golf course presumably connects people who are quite likely interested in golfing, dining, and shopping in the pro shop. People at a golf course are much more likely to welcome advertisements apprising them of good and services available at that particular golf course.

In FIG. 1, portable computing device 102 and point-of-sale (POS) system 104 are in communication with one another through a common LAN, e.g., LAN 106. Local area advertising server 112 is connected to portable computing device 102 and POS system 104, and can be connected to many other portable computing devices and POS systems coupled to other LANs, through a wide area network 110, which is the Internet in this illustrative example. It should be appreciated that, while portable computing device 102 is described herein to be portable and personal, local area advertising server 112 can facilitate local area advertising through non-portable computing devices as well.

LAN 106 is associated with a merchant, e.g., the merchant operating POS system 104. In particular, advertising managed through POS system 104 is targeted to portable computing devices that are connected to LAN 106. However, it should be noted that POS system 104 is not required to be connected to LAN 106 but can communicate with local area advertising server 112 through other networks, such as WAN 110.

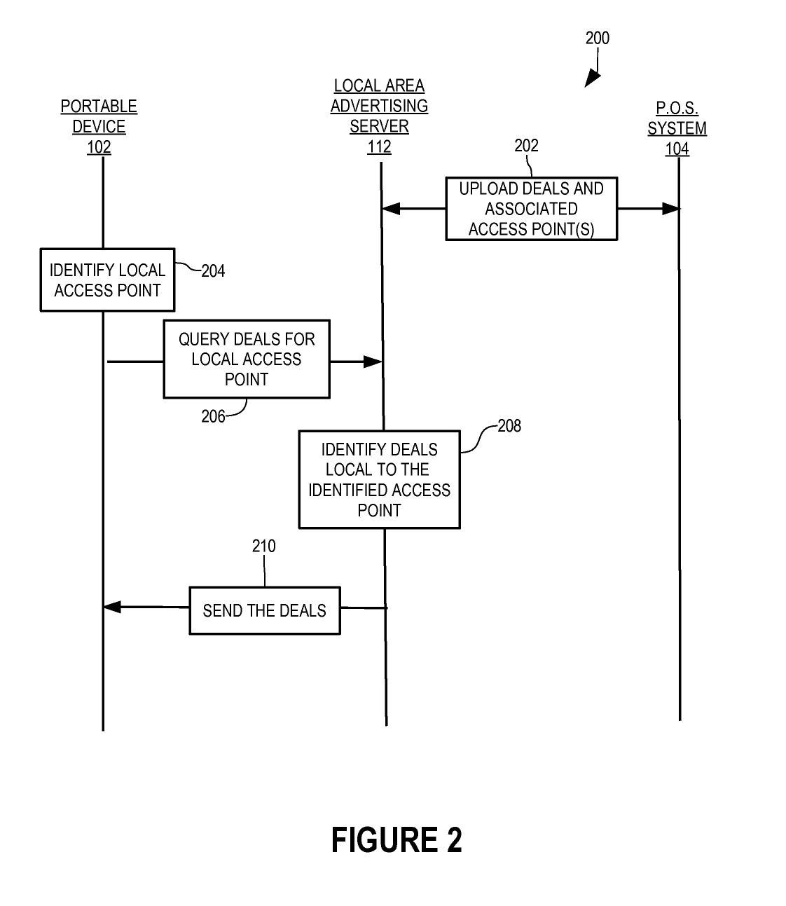

Transaction flow diagram 200 (FIG. 2) illustrates the facilitation of local area advertising between portable computing device 102 and POS system 104 by local area advertising server 112. In step 202, POS system 104 uploads advertisements to local area advertising server 112.

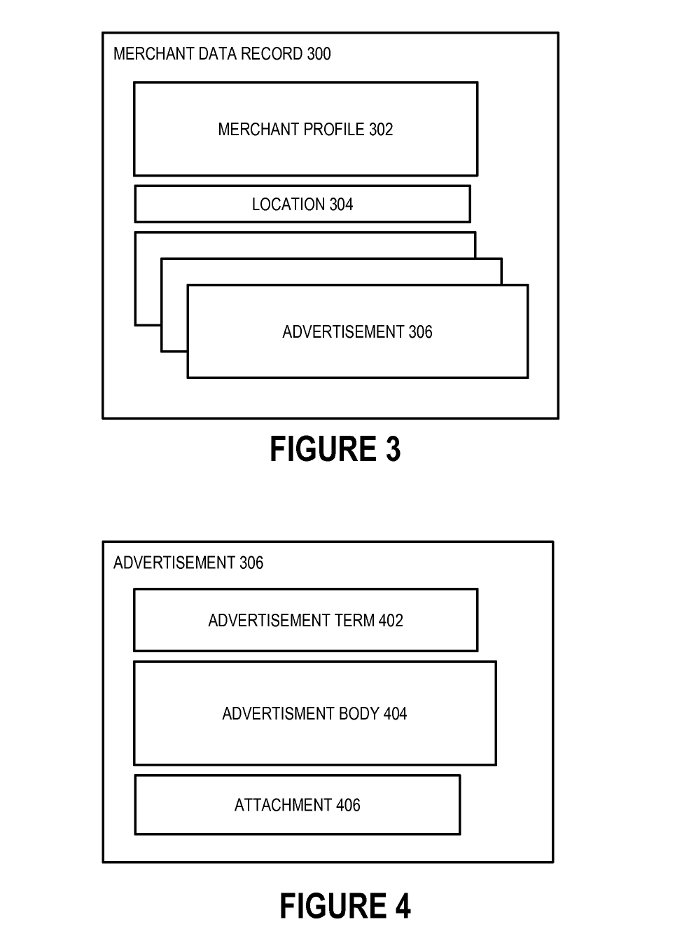

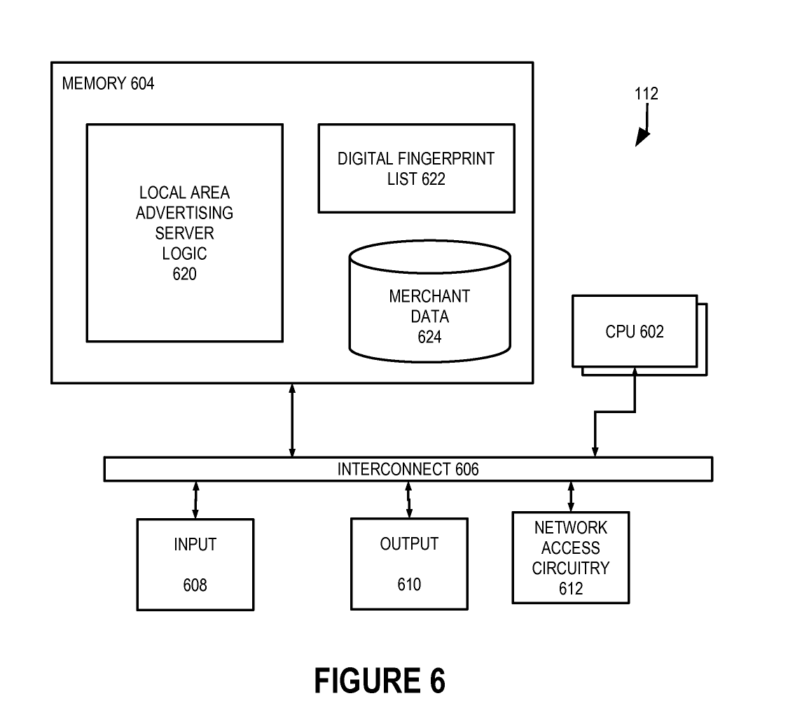

Uploading advertisements to local area advertising server 112 informs local area advertising server 112 of three primary types of information regarding a given portable computing device. These three types of information are illustrated in merchant data record 300 (FIG. 3), stored by local area advertising server 112 in merchant data 624 (FIG. 6), which is described more completely below.

Merchant data record 300 includes a merchant profile 302, a location 304, and one or more advertisements 306. Merchant profile 302 identifies the merchant. Accordingly, local area advertising server 112 can charge the merchant for the advertising service. In addition, merchant profile 302 can include data about the merchant such as location data, interior maps of the store, hours of operation, etc.

Location 304 identifies the one or more LANs through which advertisements are to be delivered to portable computing device 102. One way in which that particular LAN can be identified by local area advertising server 112 is described in commonly-owned and co-pending U.S. Patent Application 61/523,727 filed Aug. 15, 2011 for “Remote Recognition of an Association Between Remote Devices”, and that description is incorporated herein by reference. Another, particularly precise way in which that particular LAN can be identified by local area advertising server 112 is described in commonly-owned and co-pending U.S. Patent Application 61/583,126 filed Jan. 4, 2012 for “Method and System for Implementing Zone-Restricted Behavior of a Computing Device”, and that description is also incorporated herein by reference.

It should be appreciated that there is no requirement that the access points of location 304 be under control of the merchant identified by merchant profile 302. Consider the illustrative example of a café that would like to advertise to shoppers in a nearby clothing store. Management personnel of the clothing store can agree to share access point identifiers with management personnel of the café such that advertisements of the café can be delivered through the access points of the clothing store.

Advertisements 306 are the specific advertisements to be delivered to portable computing devices connected to the LAN identified by location 304. An example advertisement 306 is shown in greater detail in FIG. 4.

Advertisement term 402 specifies the dates and perhaps times advertisement 306 is valid. Advertisement body 404 is the body of advertisement 400. For example, advertisement body 404 may comprise text that communicates substantive terms of an offer for the sale of a service or merchandise, and a description of the service or merchandise. Attachment 406 is additional data to be included with advertisements 400, such as images of merchandise, video content, etc. Attachment 406 can be omitted, or multiple attachments can be included in advertisement 400.

In step 204, the user of portable computing device 102 uses local area advertising logic 520—described more completely below—to request local advertisements, and local area advertising logic 520 identifies the access point through which portable computing device may connect to LAN 106.

In step 206 (FIG. 2), local area advertising logic 520 sends a request for local advertisements to local area advertising server 112. The request includes data identifying the access point identified in step 204.

Steps 204 and 206 are in response to signals received by local area advertising logic 520 from the user that indicate a desire of the user to see local advertisements. In some such embodiments, the user can provide a textual search query for specific goods or services of immediate interest to her. Alternatively, local area advertising logic 520 can be configured to request local advertisements whenever portable computing device 102 connects to a LAN. Local area advertising logic 520 can provide a user interface whereby the user can specify one or more types of goods or services of interest, e.g., in a preferences module or an interactive browser.

In step 208, local area advertising server logic 620 (FIG. 6)—described below—of local area advertising server 112 identifies one or more advertisements that are associated with the access point identified in the request.

Local area advertising server logic 620 identifies advertisements that are local to portable computing device 102 by identifying all uploaded advertisements from merchants whose location 304 (FIG. 3) matches the identified access point.

In step 210 (FIG. 2), local area advertising logic 620 sends the identified advertisements to portable computing device 102 for display to the user.

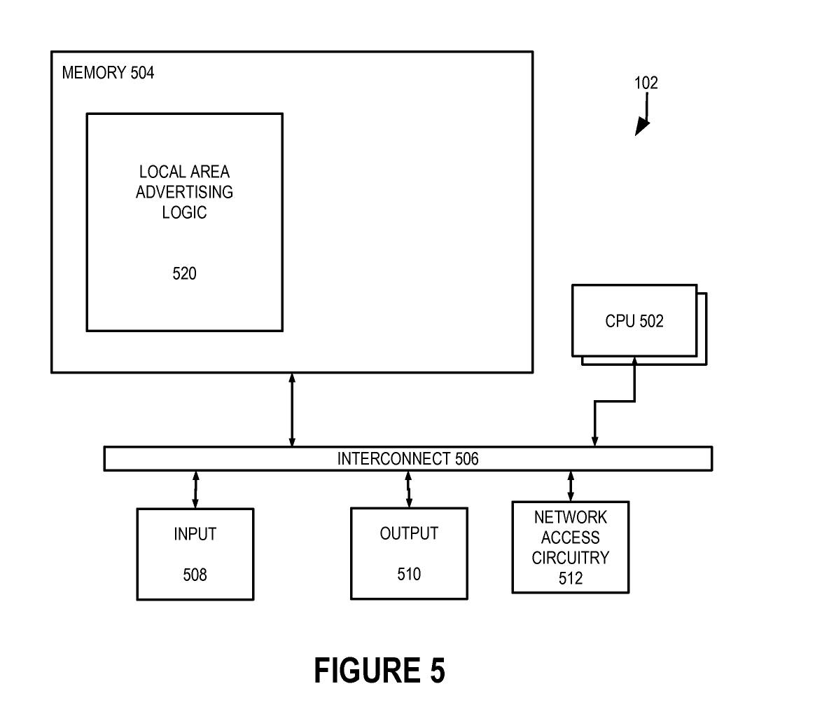

Portable computing device 102 is a portable, personal, computing device such as a smart-phone or laptop computer and is shown in greater detail in FIG. 5. Portable computing device 102 includes one or more microprocessors 502 (collectively referred to as CPU 502) that retrieve data and/or instructions from memory 504 and execute retrieved instructions in a conventional manner. Memory 504 can include generally any computer-readable medium including, for example, persistent memory such as magnetic and/or optical disks, ROM, and PROM and volatile memory such as RAM.

CPU 502 and memory 504 are connected to one another through a conventional interconnect 506, which is a bus in this illustrative embodiment and which connects CPU 502 and memory 504 to one or more input devices 508, output devices 510, and network access circuitry 512. Input devices 508 generate signals in response to physical manipulation of input devices 508 by the user and can include, for example, a keyboard, a keypad, a touch-sensitive screen, a mouse, a microphone, and one or more cameras. Output devices 510 can include, for example, a display—such as a liquid crystal display (LCD)—and one or more loudspeakers. Network access circuitry 512 sends and receives data through computer networks such as local area network 106 (FIG. 1), the Internet, and mobile device data networks, for example.

A number of components of portable computing device 102 are stored in memory 504. In particular, local area advertising logic 520 is all or part of one or more computer processes executing within CPU 502 from memory 504 in this illustrative embodiment but can also be implemented using digital logic circuitry. As used herein, “logic” refers to (i) logic implemented as computer instructions and/or data within one or more computer processes and/or (ii) logic implemented in electronic circuitry.

When executed in CPU 502 (FIG. 5) from memory 504, local area advertising logic 520 causes portable computing device 102 to behave in the manner described herein. Such behavior includes identifying a LAN access point and requesting advertisements associated with the identified access point.

Local area advertising server 112 is shown in greater detail in FIG. 6. Local area advertising server 112 includes one or more microprocessors 602 (collectively referred to as CPU 602), an interconnect 606, input devices 608, output devices 610, network access circuitry 612 that are directly analogous to CPU 502 (FIG. 5), an interconnect 506, input devices 508, output devices 510, network access circuitry 512, respectively. As local area advertising server 112 (FIG. 6) is a server computer, input devices 608 and output devices 610 can be omitted.

A number of components of local area advertising server 112 are stored in memory 604. In particular, local area advertising server logic 620 is all or part of one or more computer processes executing within CPU 602 from memory 604 in this illustrative embodiment but can also be implemented using digital logic circuitry.

Digital fingerprint list 622 is data stored persistently in memory 604. Digital fingerprints are known and are described, e.g., in U.S. Pat. No. 5,490,216 (sometimes referred to herein as the '216 Patent), and in U.S. Patent Application Publications 2007/0143073, 2007/0126550, 2011/0093920, and 2011/0093701 (collectively, “the related U.S. Patent Applications”), the descriptions of which are fully incorporated herein by reference. Briefly, a digital fingerprint is a unique identifier of an individual computing device that is derived from data stored on the device that identifies individual components of hardware or software or the system configuration of the device.

In this illustrative embodiment, merchant profile 302 (FIG. 3) may include a digital fingerprint of an associated computing device to thereby uniquely identify and recognize individual computing devices of merchants. Digital fingerprint list 622 includes a copy of the device fingerprint of each POS system 104 that is authorized to transact with advertising server 112. This provides a reliable means for the advertising server to validate advertisements that are uploaded through wide area network 110. For example, such an upload may include a copy of the POS system's digital fingerprint that can be authenticated by comparing it to each fingerprint stored in the digital fingerprint list 622. Advertising server 112 can then ignore uploaded advertisements that do not include a recognizable digital fingerprint.

Merchant data 624 is data stored persistently in memory 604. Merchant data 624 includes merchant data records such as merchant data record 300 (FIG. 3) for at least all merchants capable of uploading advertisements to local area advertising server 112. In this illustrative embodiment, portable device data 624 is organized as one or more databases.

The system according to the invention may be exploited in many ways other than those described above. For example, the invention may include a user interface operable on portable computing device 102 that allows a user to input key terms that describe multiple products or goods for which the user is shopping. This list of items may be transmitted through the communication network to the local area advertising server 112. The server 112, using local area advertising server logic 620 and merchant data 624, may then locate one or more stores or shopping centers within or nearby the local area network through which the computing device 102 has communicated, that collectively offer the best prices for the list of items, and transmit the location information back to the computing device 102. Shopping clusters such as these may be identified based on criteria other than just price. For example, a travel distance required to visit all of the stores that must be patronized to procure all of the desired items may be taken into account. Or, the user interface may allow the user to selectively disqualify certain stores when requesting the optimal cluster, i.e. the nearest cluster, the cluster with the best prices, the cluster that requires the least amount travel, etc.

A system according to the invention may also be exploited by a general manager of multiple stores, particularly for managers of large retail chains or franchises that have widely geographically distributed locations. In this scenario, general management may operate from the position of the server 112, and operational control may flow from server 112 to multiple LANs 106, where each LAN 106 is located within or nearby a different one of multiple distributed retail stores. Through this arrangement, the general manager may launch test marketing schemes by selectively transmitting deals or offers to one or a few (or any number) of stores. For example, in determining an optimal sales price for a new product prior to nationwide release, deals for the product may be made available through a small sample of LANs, with each deal specifying a different price, so that sales data may be collected and analyzed to determine which price provokes the most sales revenue. To realize such a scheme, a user interface may be provided for the general manager that allows for selection of control parameters such as the LANs, the prices, and the durations of the offers.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for disseminating local area advertising to a computing device, the method comprising the following steps executed at a local area advertising server:
receiving a data record from point-of-sale computing system, the data record including an advertisement and identifying an associate local area network through which the advertisement is to be delivered;
receiving a request for advertisements from the computing device through a computer network, wherein the request identifies the local area network to which the computing device is connected;
identifying the advertisement that is associated with the local area network; and
sending the advertisement to the computing device.

2. The method of claim 1, wherein the data record received from the point-of-sale computing system is not transmitted through the local area network.

3. The method of claim 2 wherein the request is sent by the computing device automatically and without human intervention upon detection by the computing device of connection of the computing device to a local area network.

4. The method of claim 3 wherein the computing device is a mobile computing device wirelessly connected to the local area network.

5. The method of claim 1 wherein the request is sent by the computing device automatically and without human intervention upon detection by the computing device of connection of the computing device to a local area network.

6. The method of claim 1 wherein the computing device is a mobile computing device wirelessly connected to the local area network.

7. A computer system comprising:
at least one processor;
a computer readable medium that is operatively coupled to the processor;
network access circuitry that is operatively coupled to the processor; and
local area advertising server logic (i) that executes in the processor from the computer readable medium and (ii) that, when executed by the processor, causes the computer to facilitate local area advertising to a computing device by at least:
receiving a data record from a point-of-sale computing system, the data record including as advertisement and identifying an associated local area network through which the advertisement is to be delivered;
receiving a request for advertisements from the computing device through a computer network, wherein the request identifies the local area network to which the computing device is connected;
identifying the advertisement that are associated with the local area network; and
sending the advertisements to the computing device.
